(19) United States
(12) Patent Application Publication
(10) Pub. No.: US 2016/0104417 A1
(43) Pub. Date: Apr. 14, 2016

(54) MESSAGING SYSTEM FOR VEHICLE

(71) Applicant: Brett Jason Gahagan, San Diego, CA (US)

(72) Inventor: Brett Jason Gahagan, San Diego, CA (US)

(21) Appl. No.: 14/511,446

(22) Filed: Oct. 10, 2014

(51) Int. Cl. G09G 3/32; B60Q 1/26; B60Q 1/50; B60Q 5/00

(52) U.S. Cl. CPC G09G 3/3208; B60Q 5/00; B60Q 1/2619; B60Q 1/503

(57) ABSTRACT

A display such as an organic light emitting diode (OLED) display may be mounted on a vehicle and controlled by a control device such as a smart phone to present messages, including text and images if desired, on the sign.

### FIELD OF THE INVENTION

The present application relates generally to messaging systems for vehicles.

### BACKGROUND OF THE INVENTION

Present principles recognize that people in vehicles may want to send short visible messages to people in other vehicles.

### SUMMARY OF THE INVENTION

Accordingly, in one aspect a device includes a non-transitory memory accessible to a processor and having instructions executable by the processor to receive user selection of a message to be presented on a sign located on a vehicle, and wirelessly send the message to the sign for presentation of the message on the sign.

The device may be implemented by a wireless communication device (WCD) such as a smart phone. The message can include text and/or audio and/or at least one image.

In some embodiments the instructions when executed by the processor configure the processor to determine whether the sign is disposed on an approved vehicle surface. Responsive to determining that the sign is not disposed on an approved vehicle surface, the instructions when executed by the processor configure the processor for not causing the message to be presented on the sign. On the other hand, responsive to determining that the sign is disposed on an approved vehicle surface, the instructions when executed by the processor configure the processor for causing the message to be presented on the sign.

In examples, the instructions when executed by the processor configure the processor to determine whether content in the message satisfies at least one filter. Responsive to determining that the content does not satisfy the filter, the instructions when executed by the processor configure the processor for not presenting the content as entered on the sign. In contrast, responsive to determining that the content does satisfy the filter, the instructions when executed by the processor configure the processor for presenting the content as entered on the sign.

In some implementations the instructions when executed by the processor configure the processor to cause at least display circuitry of the sign to remain deenergized unless a message is caused to be presented on the sign. In non-limiting examples, the instructions when executed by the processor configure the processor to present on a display separate from the sign the message presented on the sign responsive to presenting the message on the sign.

In another aspect, a system includes an electronic display mounted on a vehicle and controlled by a control device to present messages, including text and/or images, on the electronic display.

In another aspect, a method includes entering a message into an electronic device, and causing the message to be presented on an electronic sign mounted on a vehicle.

The details of present principles, both as to their structure and operation, can best be understood in reference to the accompanying drawings, in which like reference numerals refer to like parts, and in which:

### DESCRIPTION OF THE DRAWINGS

FIG. 1 is a block diagram of a non-limiting example system in accordance with present principles;

FIG. 2 is a block diagram of a non-limiting example network of devices in accordance with present principles;

FIG. 3 is a schematic diagram of the sign on a vehicle;

FIG. 4 is an example message entry user interface (UI);

FIG. 5 is a flow chart of example logic; and

FIG. 6 is an example message notification UI.

### DETAILED DESCRIPTION

This disclosure relates generally to device-based information. With respect to any computer systems discussed herein, a system may include server and client components, connected over a network such that data may be exchanged between the client and server components. The client components may include one of more computing devices including televisions, computers such as desktops, laptops and tablet computers, in-vehicle engine control modules (ECM), so-called convertible devices (e.g. having a tablet configuration and laptop configuration), and other mobile devices including smart phones. These client devices may employ, as non-limiting examples, operating systems from Apple, Google, or Microsoft. A Unix or similar such as Linux operating system may be used. These operating systems can execute one or more browsers such as a browser made by Microsoft or Google or Mozilla or other browser program that can access web applications hosted by the Internet servers over a network such as the Internet, a local intranet, or a virtual private network.

As used herein, instructions refer to computer-implemented steps for processing information in the system. Instructions can be implemented in software, firmware or hardware; hence, illustrative components, blocks, modules, circuits, and steps are set forth in terms of their functionality.

A processor may be any conventional general purpose single- or multi-chip processor that can execute logic by means of various lines such as address lines, data lines, and control lines and registers and shift registers. Moreover, any logical blocks, modules, and circuits described herein can be implemented or performed, in addition to a general purpose processor, in or by a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can be implemented by a controller or state machine or a combination of computing devices.

Any software and/or applications described by way of flow charts and/or user interfaces herein can include various sub-routines, procedures, etc. It is to be understood that logic divulged as being executed by e.g. a module can be redistributed to other software modules and/or combined together in a single module and/or made available in a shareable library.

Logic when implemented in software, can be written in an appropriate language such as but not limited to C# or C++, and can be stored on or transmitted through a computer-readable storage medium (e.g. that may not be a carrier wave) such as a random access memory (RAM), read-only memory (ROM), electrically erasable programmable read-only memory (EEPROM), compact disk read-only memory (CD-ROM) or other optical disk storage such as digital versatile disc (DVD), magnetic disk storage or other magnetic storage devices including removable thumb drives, etc. A connection may establish a computer-readable medium. Such connections can include, as examples, hard-wired cables including fiber optics and coaxial wires and twisted pair wires. Such connections may include wireless communication connections including infrared and radio.

In an example, a processor can access information over its input lines from data storage, such as the computer readable storage medium, and/or the processor can access information wirelessly from an Internet server by activating a wireless transceiver to send and receive data. Data typically is converted from analog signals to digital by circuitry between the antenna and the registers of the processor when being received and from digital to analog when being transmitted. The processor then processes the data through its shift registers to output calculated data on output lines, for presentation of the calculated data on the device.

Components included in one embodiment can be used in other embodiments in any appropriate combination. For example, any of the various components described herein and/or depicted in the Figures may be combined, interchanged or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

“A system having one or more of A, B, and C” (likewise “a system having one or more of A, B, or C” and “a system having one or more of A, B, C”) includes systems that have A alone, B alone, C alone, A and B together, A and C together, B and C together, and/or A, B, and C together, etc.

The term “circuit” or “circuitry” is used in the summary, description, and/or claims. As is well known in the art, the term “circuitry” includes all levels of available integration, e.g., from discrete logic circuits to the highest level of circuit integration such as VLSI, and includes programmable logic components programmed to perform the functions of an embodiment as well as general-purpose or special-purpose processors programmed with instructions to perform those functions.

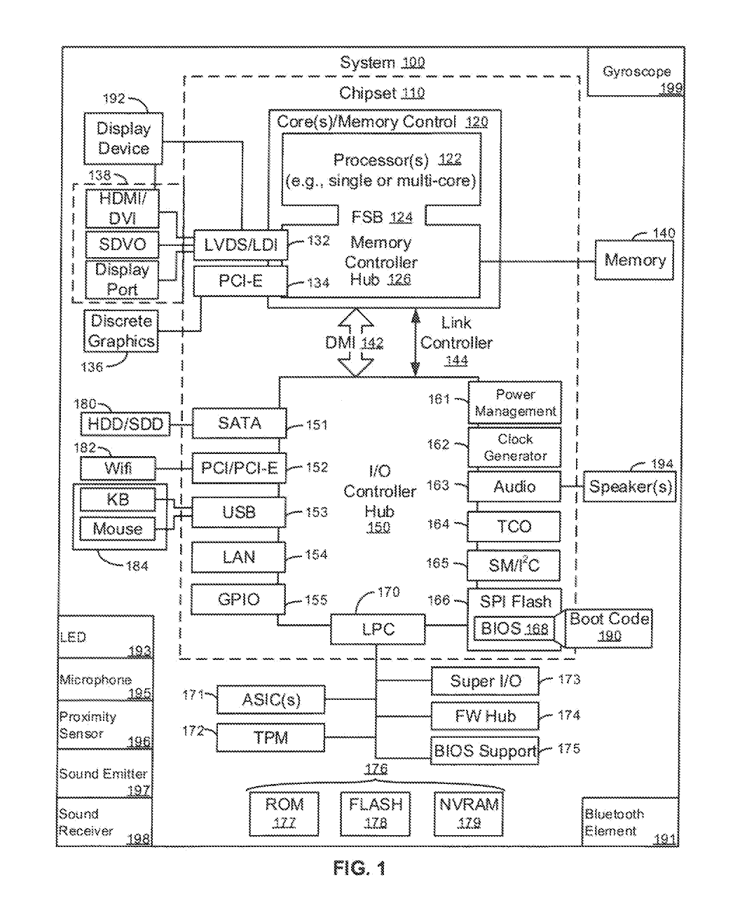

Now specifically in reference to FIG. 1, it shows an example block diagram of an information handling system and/or computer system 100. Note that in some embodiments the system 100 may be a desktop computer system or a hand-held computer system such as a “smart phone”; however, as apparent from the description herein, a client device, a server or other machine in accordance with present principles may include other features or only some of the features of the system 100. Also, the system 100 may be e.g. a game console such as XBOX® or Playstation®.

As shown in FIG. 1, the non-limiting example system 100 can include a so-called chipset 110. A chipset refers to a group of integrated circuits, or chips, that are designed to work together. Chipsets are usually marketed as a single product (e.g., consider chipsets marketed under the brands INTEL®, AMD®, etc.).

In the example of FIG. 1, the chipset 110 may have a particular architecture, which may vary to some extent depending on brand or manufacturer. The architecture of the chipset 110 may include a core and memory control group 120 and an I/O controller hub 150 that exchange information (e.g., data, signals, commands, etc.) via, for example, a direct management interface or direct media interface (DMI) 142 or a link controller 144. In the example of FIG. 1, the DMI 142 can be a chip-to-chip interface (sometimes referred to as being a link between a “northbridge” and a “southbridge”).

The core and memory control group 120 can include one or more processors 122 (e.g., single core or multi-core, etc.) and a memory controller hub 126 that exchange information via a front side bus (FSB) 124. As described herein, various components of the core and memory control group 120 may be integrated onto a single processor die, for example, to make a chip that supplants the conventional “northbridge” style architecture.

The memory controller hub 126 may interface with memory 140. For example, the memory controller hub 126 may provide support for DDR SDRAM memory (e.g., DDR, DDR2, DDR3, etc.). In general, the memory 140 may be a type of random-access memory (RAM). It is often referred to as “system memory.”

The memory controller hub 126 may further include a low-voltage differential signaling interface (LVDS) 132. The LVDS 132 may be a so-called LVDS Display Interface (LDI) for support of a display device 192 (e.g., a CRT, a flat panel, a projector, a touch-enabled display, etc.). A block 138 includes some examples of technologies that may be supported via the LVDS interface 132 (e.g., serial digital video, HDMI/DVI, display port). The memory controller hub 126 may also include one or more PCI-express interfaces (PCI-E) 134, for example, for support of discrete graphics 136. Discrete graphics using a PCI-E interface has become an alternative approach to an accelerated graphics port (AGP). For example, the memory controller hub 126 may include a 16-lane (x16) PCI-E port for an external PCI-E-based graphics card (including e.g. one of more GPUs). An example system may include AGP or PCI-E for support of graphics.

The I/O hub controller 150 can include a variety of interfaces. The example of FIG. 1 includes a SATA interface 151, one or more PCI-E interfaces 152 (optionally one or more legacy PCI interfaces), one or more USB interfaces 153, a LAN interface 154 (more generally a network interlace for communication over at least one network such as the Internet, a WAN, a LAN, etc. under direction of the processor(s) 122), a general purpose I/O interface (GPIO) 155, a low-pin count (LPC) interface 170, a power management interface 161, a clock generator interface 162, an audio interface 163 (e.g., for speakers 194 to output audio), a total cost of operation (TCO) interface 164, a system management bus interface (e.g., a multi-master serial computer bus interface) 165, and a serial peripheral flash memory/controller interface (SPI Flash) 166, which, in the example of FIG. 1, includes BIOS 168 and boot code 190. With respect to network connections, the I/O hub controller 150 may include integrated gigabit Ethernet controller lines multiplexed with a PCI-E interface port. Other network features may operate independent of a PCI-E interface.

The interfaces of the I/O hub controller 150 can provide for communication with various devices, networks, etc. For example, the SATA interface 151 may provide for reading, writing or reading and writing information on one or more drives 180 such as HDDs, SDDs or a combination thereof, but in any case the drives 180 are understood to be e.g. tangible computer readable storage mediums that may not be carrier waves. The I/O hub controller 150 may also include an advanced host controller interface (AHCI) to support one or more drives 180. The PCI-E interface 152 allows for wireless connections 182 to devices, networks, etc. The USB interface 153 provides for input devices 184 such as keyboards (KB), mice and various other devices (e.g., cameras, phones, storage, media players, etc.).

In the example of FIG. 1, the LPC interface 170 provides for use of one or more ASICs 171, a trusted platform module (TPM) 172, a super I/O 173, a firmware hub 174, BIOS support 175 as well as various types of memory 176 such as ROM 177, Flash 178, and non-volatile RAM (NVRAM) 179. With respect to the TPM 172, this module may be in the form of a chip that can be used to authenticate software and hardware devices. For example, a TPM may be capable of performing platform authentication and may be used to verify that a system seeking access is the expected system.

The system 100, upon power on, may be configured to execute boot code 190 for the BIOS 168, as stored within the SPI Flash 166, and thereafter processes data under the control of one or more operating systems and application software (e.g., stored in system memory 140). An operating system may be stored in any of a variety of locations and accessed, for example, according to instructions of the BIOS 168.

Also shown is at least one lamp 193 which may be e.g. a light emitting diode (LED). It is to be understood that the lamp 193 may be positioned at least partially on a portion of a housing of the system 100 that does not form part of the display device 192, and/or may be positioned on a portion of the display device 192 such as e.g. a generally-blackened periphery of the display device 192 not configured to present images, user interfaces, application windows, etc. It is to be further understood that the at least one lamp 193 may be configured to change colors emitted therefrom under control of the processor 122 such as e.g. being configured to emit green light, orange light, blue light, red light, and/or yellow light. Notwithstanding, it is to be understood that in some embodiments the at least one lamp 193 may be plural lights each being respectively configured to emit light of a different color such as e.g. green light, orange light, blue light, red light, and yellow light.

The system 100 of FIG. 1 may also include an audio receiver/microphone 195 providing input to the processor 122 e.g. based on a use providing audible input to the microphone, as well as a proximity, motion, infrared, sonar, and/or heat sensor 196 providing input to the processor 122 and configured in accordance with present principles for sensing e.g. proximity of one or more persons (e.g. to the system 100), motion of one or more persons, body heat of one or more persons, etc. Still further, the system 100 may include a sound emitter 197 configured to emit sound e.g. detectable by a sound receiver 198 to e.g. execute active or passive echo detection in accordance with present principles. Note that the sound receiver 198 may also used to identify sound distortion(s) in accordance with present principles.

Still in reference to the system 100 of FIG. 1, it may also include a camera 199 for gathering one or more images and providing input related thereto to the processor 122. The camera may be, e.g., a thermal imaging camera, a digital camera such as is webcam, and/or a camera integrated into the system 100 and controllable by the processor 122 to gather pictures/images and/or video of one or more people in accordance with present principles. Also shown is a Bluetooth element 191 configured for communication with other devices including other Bluetooth-enabled devices and/or Bluetooth beacons using Bluetooth communication standards. Thus, the Bluetooth element 191 may be implemented as a Bluetooth Low Energy (BLE) module and/or a Bluetooth 4.0 module that transmits data using one or more of BLE communication and/or standard Bluetooth communication.

Additionally, in some embodiments the system 100 may include a gyroscope for sensing providing and/or measuring the orientation the system 100 and providing input related thereto to the processor 122, and an accelerometer for e.g. sensing acceleration and/or movement of the system 100 and providing input related thereto to the processor 122. Still further, the system 100 may include a GPS transceiver that is configured to e.g. receive geographic position information from at least one satellite and provide the information to the processor 122. However, it is to be understood that another suitable position receiver other than a GPS receiver may be used in accordance with present principles to e.g. determine the location of the system 100.

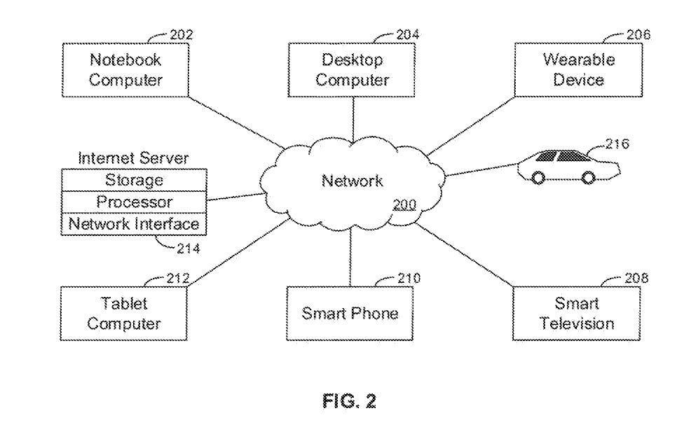

Before moving on to FIG. 2, it is to be understood that an example client device or other machine/computer may include fewer or more features than shown on the system 100 of FIG. 1. In any case, it is to be understood at least based on the foregoing that the system 100 is configured to undertake present principles.

Turning now to FIG. 2, it shows example devices communicating over a network 200 such as e.g. the Internet in accordance with present principles. It is to be understood that each of the devices described in reference to FIG. 2 may include at least some of the features, components, and/or elements of the system 100 described above. In any case, FIG. 2 shows a notebook computer 202, a desktop computer 204, a wearable device 206 such as e.g. a smart watch, a smart television (TV) 208, a smart phone 210, a tablet computer 212, and a vehicle 216. The vehicle 216 author component thereof, such as the below-described electronic sign, may comprise some or all of the components discussed above with respect to the system 100, and furthermore may include e.g. a passenger sensor for sensing whether a passenger is positioned in a passenger seat, a passenger airbag sensor for sensing whether a passenger airbag has been enabled, a passenger seatbelt sensor for sensing whether a passenger seat belt has been engaged, a weight sensor for sensing weight of the vehicle 216 and weight distribution of the vehicle 216, etc.

In addition to the foregoing, the network 200 includes a server 214 such as e.g. an Internet server that may e.g. provide cloud storage accessible to the devices 202-212 and 216. It is to be understood that the devices 202-216 are configured to communicate with each other over the network 200 and/or through a direct short range protocol such as Bluetooth to undertake present principles.

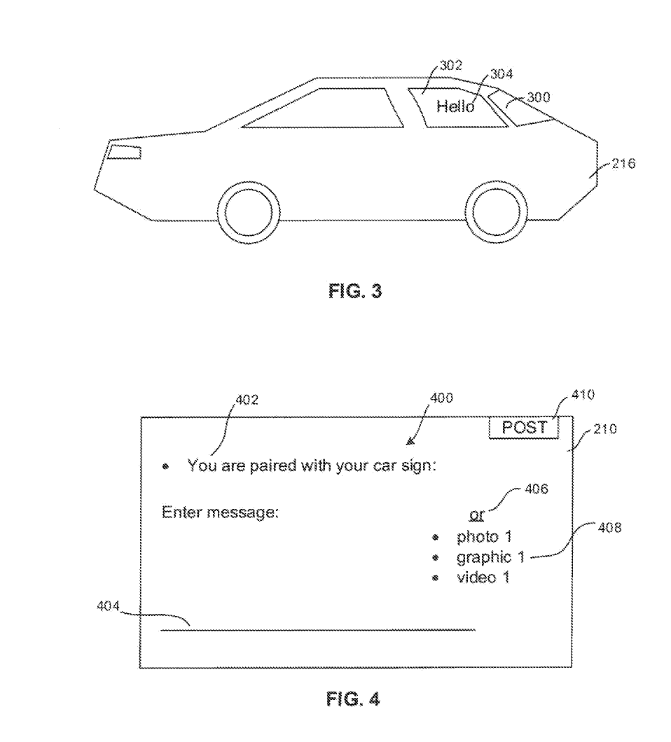

Referring now to FIG. 3, the vehicle 261 shown in FIG. 2 may include one or more surfaces 300. In the example shown, the surface 300 is a side window, although other surfaces are contemplated herein for present purposes, including, e.g., a rear window, a door panel, a quarter panel, a rear trunk, an engine compartment hood, etc.

An electronic sign 302 is disposed on the surface 300 as shown. The sign 302 may be battery-powered if desired. Without limitation the electronic sign may be an organic light emitting display (OLED) such as that disclosed in U.S. Pat. No. 7,780,322, incorporated herein by reference, or any of the OLED made by LG Electronics. The sign 302 may be controlled by a computer such as a processor integrated into the sign itself and communicating with an input device integrated into the vehicle or communicating with, e.g., a user's smart phone 200 via, e.g., Bluetooth or Wi-Fi or other appropriate protocol to display a user-selectable message 304 (“hello”, in the example shown). The sign 302 may be fastened or glued to the surface 300 or it may be laid over the surface and removably held thereon by electrostatic force and/or the tackiness of the sign. In this way the sign 302 may be quickly placed onto, e.g., the interior surface of a side window of the vehicle without further installation steps.

For example, the sign 302 may be installed on the surface 300 by the vehicle manufacturer or by an owner of the vehicle as an after-market item. In any case, a person may pair their smart phone 210 with the sign 302 using Bluetooth pairing procedures or may otherwise establish communication with the sign. In an example, a person can download an application from, e.g., the Internet server 214 which is tailored to be executed by the smart phone to receive user input and control the sign 302 according to principles below to present the message 304 in accordance with the user input.

For example, FIG. 4 shows a user interface (UI) 400 that can be presented on a display such as the display device 192 incorporated into the smart phone 210, it being understood that alternatively the UI 400 may be presented on a vehicle-mounted display that is built into the vehicle 216 or on another suitable control device. The UI 400 may present a message 402 indicating that the control device has successfully paired with the sign 302 and may thus control it by, e.g., entering a message into a field 404. Without limitation, data entry into the field 404 may be executed using a touch screen feature of the display or using a keyboard or keypad entry device or by voice entry. Data may be text data for presentation of a text message on the sign 302. Or, the user may select a photograph or graphic or even a video file from, e.g., internal memory of the smart phone 210 or from cloud-based data storage by selecting from a drop-down menu 406 an entry 408, which may be a thumbnail image of the underlying asset to be presented on the sign 302. Regardless of whether the message is text or an image, the user can then select an enter selector 410 to send the data to the sign 302 for presentation thereof on the sign.

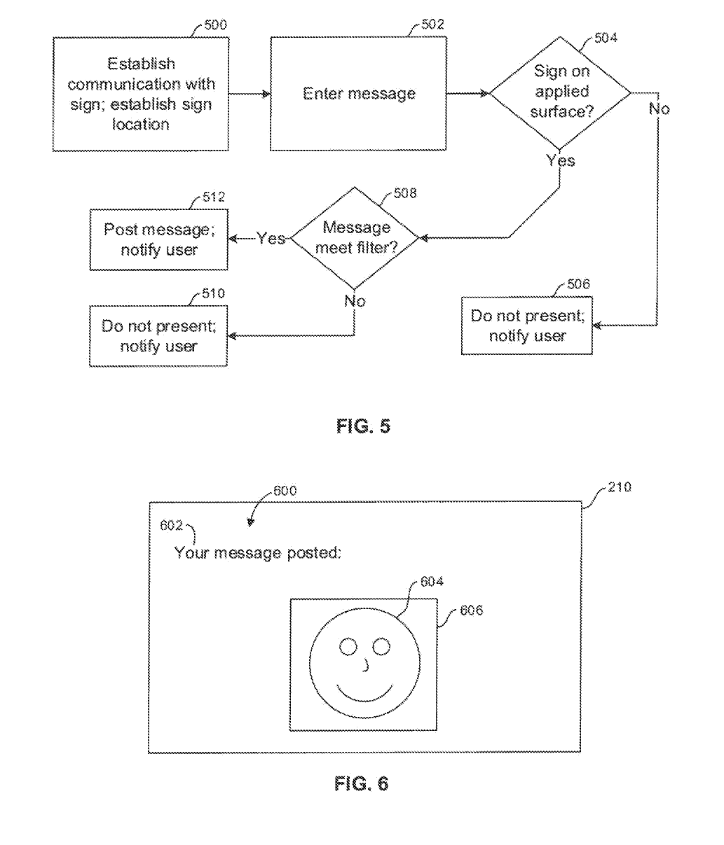

FIG. 5 illustrates example logic. Commencing at block 500, the control device such as the user's smart phone 210 executing a downloaded application establishes communication with the sign 304 as by, e.g., Bluetooth pairing. Also, the location of the sign 302 on the vehicle 216 may be established if desired. This may be done by a user entering the location into the control device, e.g., “side window”, or it may be done by deriving from position signals generated by a GPS receiver on the sign an inference of location. As but one example, the sign's GPS can be compared to the GPS of the smart phone 210. Assuming the vehicle is in motion, the direction of motion as sensed by the GPS receivers cooperating with respective processors can be inferred to define the “front” direction, and if the GPS position of the sign is in front of the GPS position of the smart phone, it may be inferred that the sign is on a front surface of the vehicle under the assumption that the smart phone is located in the passenger compartment of the vehicle.

A message may be entered into the control device at block 502 according to principles above. In example embodiments the logic may move to decision diamond 504 to determine whether the sign 302 is disposed on an approved vehicle surface as indicated by the example methods of entering vehicle surface discussed in relation to block 500. As an example, the front windshield and/or other locations forward of the passenger compartment may be a disapproved surface, whereas the site or rear windows may be approved surfaces. If the determination at decision diamond 504 is negative, the processor may move to block 506, in which the message is not presented on the sign and the user is notified. In such a case, the sign may be deenergized if energized or it may remain deenergized if already off.

On the other hand, if the sign is determined to be on an approved surface the logic may in some examples move to decision diamond 508 to determine whether the message satisfies one or more filters. As an example, if the message is a text message, the text may be compared against a database of forbidden words to determine if the message passes the filter, and if one or more words in the text is on the disapproved list, the offending text is not presented at block 510 and the user notified. Equivalently, in a multi-word message, only disapproved terms are not presented and the remaining text is presented on the sign. Yet again, placeholders such as asterisks may be substituted for one or more letters of a disapproved word in the text and the modified word(s) presented on the sign accordingly.

In the case of images, the processor of the control device may execute image recognition to determine whether any portion of the image sought to be presented on the sign is inappropriate. The image may be compared against a database of forbidden images or image types and if a match is found, the message is not posed on the sign at block 510.

Approved messages (either passing all filters as entered and/or passing the filters after modification as described above) are presented on the sign at block 512. The sign (except for control and communication circuitry) may be energized only at block 512 so that until the message is posted, the sign remains dark, conserving power.

Also, the user may be notified of successful message posting on the sign as shown in FIG. 6. A UI 600 may be presented on the control device such as a display of a smart phone 210 in which the user is presented with a message 602 that the message entered by the user by means of the control device has been successfully posted on the sign. Also, a small copy 604 of the image that was posted on the sign may be presented in a window 606 of the control device, so that the user knows what the sign is showing just by looking at the display of the control device. In the example shown, the posted message is an image of a face, but as described above it could be text, video, or a combination of these. The message on the sign may be removed after a timeout period and the display circuitry of the sign deenergized, and/or the message on the sign may be removed upon user command entered into the control device.

In addition to images, the sign may include or be established by an audio speaker and the message it presents may be audio such as the user's voice entry into the control device or a user-selected song sourced from the cloud.

While the particular MESSAGING SYSTEM FOR VEHICLE is herein shown and described in detail, it is to be understood that the subject matter which is encompassed by the present application is limited only by the claims.

What is claimed is:

1. A device, comprising:
a non-transitory memory accessible to a processor and having instructions executable by the processor to:
receive user selection of a message to be presented on a sign located on a vehicle; and
wirelessly send the message to the sign for presentation of the message on the sign.

2. The device of claim 1, wherein the device is implemented by a wireless communication device (WCD).

3. The device of claim 1, wherein the message includes text.

4. The device of claim 1, wherein the message includes audio.

5. The device of claim 1, wherein the message includes at least one image.

6. The device of claim 1, wherein the instructions when executed by the processor configure the processor to:
determine whether the sign is disposed on an approved vehicle surface;
responsive to determining that the sign is not disposed on an approved vehicle surface, not causing the message to be presented on the sign; and
responsive to determining that the sign is disposed on an approved vehicle surface, causing the message to be presented on the sign.

7. The device of claim 1, where the instructions when executed by the processor configure the processor to:
determine whether content in the message satisfies at least one filter;
responsive to determining that the content does not satisfy the filter, not presenting the content as entered on the sign; and
responsive to determining that the content does satisfy the filter, presenting the content as entered on the sign.

8. The device of claim 1, wherein the instructions when executed by the processor configure the processor to:
cause at least display circuitry of the sign to remain deenergized unless a message is caused to be presented on the sign.

9. The device of claim 1, wherein the instructions when executed by the processor configure the processor to:
present on a display separate from the sign the message presented on the sign responsive to presenting the message on the sign.

10. System comprising:
an electronic display mounted on a vehicle and controlled by a control device to present messages, including text and/or images, on the electronic display.

11. The system of claim 10, comprising the vehicle.

12. The system of claim 11, comprising the control device.

13. The system of claim 10, comprising the control device.

14. The system of claim 10, wherein the electronic display is established by an organic light emitting diode (OLED) display.

15. Method comprising:
entering a message into an electronic device; and
causing the message to be presented on an electronic sign mounted on vehicle.

16. The method of claim 15, wherein the electronic device is implemented by a wireless communication device (WCD).

17. The method of claim 15, wherein the message includes text.

18. The method of claim 15, wherein the message includes audio.

19. The method of claim 15, wherein the message includes at least one image.

20. The method of claim 15, wherein the electronic sign is established by an organic light emitting diode (OLED) display.
